(19) United States
(12) Patent Application Publication
(10) Pub. No.: US 2008/0244416 A1
(43) Pub. Date: Oct. 2, 2008

(54) APPARATUS AND METHOD FOR CREATING AND CONSUMING CUSTOM VISUALIZATION TEMPLATES

(75) Inventors: Bruno Andre Marie DUMANT, Verneuil sur Seine (FR); Dan Cristian MARINESCU, Versailles (FR); Gregoire Jean Antoine CACHEUX, Puteaux (FR); Alexis-Jean Laurent Naibo, Levallois-Perret (FR); Steve KOPP, Paris (FR)

Correspondence Address: COOLEY GODWARD KRONISH LLP;ATTN: Patent Group, Suite 1100, 777 - 6th Street, NW, Washington, DC, 20001, US

(73) Assignee: BUSINESS OBJECTS, S.A., Levallois-Perret (FR)

(21) Appl. No.: 11/692,894

(22) Filed: Mar. 28, 2007

(51) Int. Cl. G06F 3/00

(52) U.S. Cl. 715/744

(57) ABSTRACT

A computer readable storage medium includes executable instructions to access multiple custom templates. A selected custom template is designated for implementation. The selected custom template has a set of associated parameters. A custom template guide corresponding to the selected custom template is initiated.

### BRIEF DESCRIPTION OF THE INVENTION

This invention relates generally to computer generated visualizations. More particularly, this invention relates to techniques for creating and consuming custom templates for such visualizations.

### BACKGROUND OF THE INVENTION

Visualization templates are provided by application vendors, restricting a user to what the vendor anticipates their needs to be. The user may end up spending large amounts of time creating similar visualizations that the vendor did not anticipate.

In view of the foregoing, it would be beneficial to provide a system that gives the user more control, flexibility and variety in their template selection. Generating a template consumption guide to go along with each custom template would allow the user to get as much flexibility and usefulness out of custom templates as vendor provided templates. Additionally, allowing users and vendor partners to publish custom templates to a repository would give them more variety in their template options.

### SUMMARY OF INVENTION

The invention includes a computer readable storage medium with executable instructions to access multiple custom templates. A selected custom template is designated for implementation. The selected custom template has a set of associated parameters. A custom template guide corresponding to the selected custom template is initiated.

The invention also includes a computer readable storage medium with executable instructions to access multiple custom templates. A selected custom template is designated for implementation. The selected custom template has a set of associated parameters. A custom template guide corresponding to the selected custom template is initiated. A set of values which correspond to the set of associated parameters are accepted via the custom template guide. An instance of a visualization is rendered in accordance with the set of values.

The invention also includes a computer readable storage medium with executable instructions to access multiple custom templates. A selected custom template is designated for implementation in a report. The selected custom template has a set of associated parameters. A custom template guide corresponding to the selected custom template is initiated. A set of values which correspond to the set of associated parameters is requested via the custom template guide. An instance of a visualization is rendered in accordance with the set of values. The instance of the visualization is then inserted into the report.

### BRIEF DESCRIPTION OF THE FIGURES

The invention is more fully appreciated in connection with the following detailed description taken in conjunction with the accompanying drawings, in which:

FIG. 1 illustrates a system including two or more coupled computers configured in accordance with an embodiment of the invention.

FIG. 2 illustrates processing operations associated with an embodiment of the invention.

FIG. 3 illustrates a Graphical User Interface guide for creating a custom template configured in accordance with an embodiment of the invention.

FIG. 4 illustrates a preview tab configured in accordance with an embodiment of the invention.

FIG. 5 illustrates a Graphical User Interface guide for consuming a custom template configured in accordance with an embodiment of the invention.

FIG. 6 illustrates a template customization tab configured in accordance with an embodiment of the invention.

FIG. 7 illustrates a pivot tab configured in accordance with an embodiment of the invention.

FIG. 8 illustrates a visualization configured in accordance with an embodiment of the invention.

Like reference numerals refer to corresponding parts throughout the several views of the drawings.

### DETAILED DESCRIPTION OF THE INVENTION

The following terminology is used while disclosing embodiments of the invention:

A custom template is a user specified model or pattern for making multiple copies of a single visualization (e.g., a pie chart, a bar chart, a mashup). A custom template may require object specific parameter specifications on implementation (e.g., data mapping, size, visualization type).

A guide is a form that accepts parameters for an object (e.g., data mapping, size, visualization type). The guide is used to create or edit an object. The guide indicates required parameters and default values. The guide may be organized into multiple tabs in a single pane or a series of single-tabbed panes. The series of single-tabbed panes present the process of creating an object step-by-step, similar to a document creation wizard or a software installation wizard.

A mashup combines content from more than one source. Mashup content is typically sourced from a third party via a public interface or API. Mashups come in many forms including websites, applications and visualizations.

An object is a visualization or document (e.g., a chart, a map, a report). An object maybe generalized to a template format.

A visualization is a graphic display of quantitative information. Types of visualizations include charts, tables and maps. A visualization is a form of mashup.

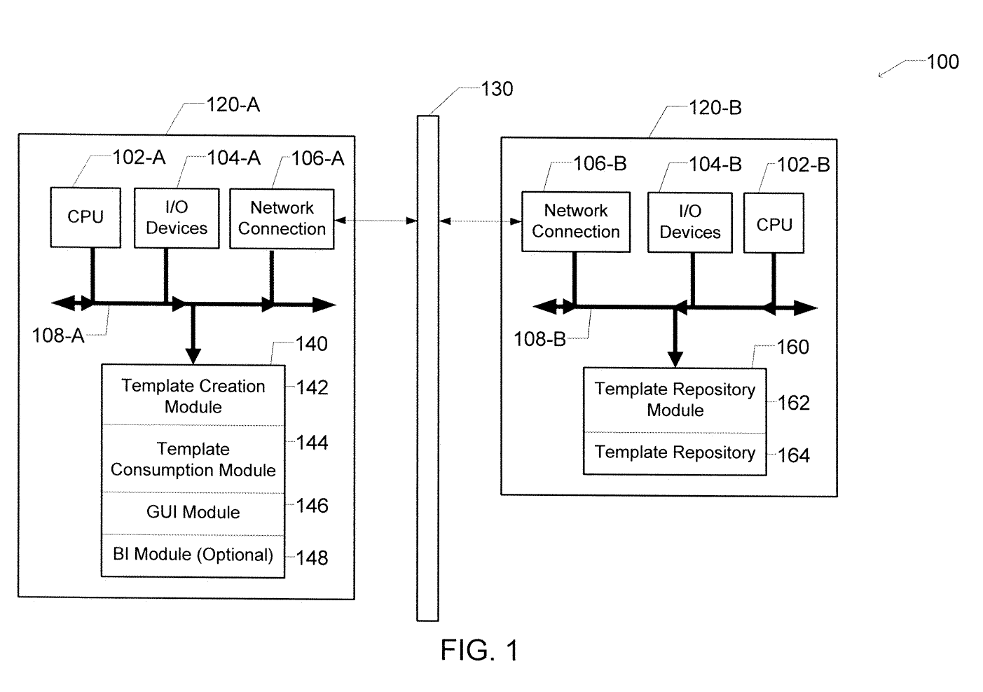

FIG. 1 illustrates a system 100 configured in accordance with an embodiment of the invention. The system 100 includes two or more coupled computers, e.g., arranged in a client-server architecture. The system 100 includes a first computer 120-A and a second computer 120-B. A data signal can be sent from the first computer to the second computer and vice versa via communication channel 130, which may be any wired or wireless channel.

Each computer 120 includes a central processing unit 102 connected to a set of input/output devices 104 and a network connection circuit 106 via a bus 108. As shown in FIG. 1, computer 120-A includes a CPU 102-A, input/output devices 104-A, a network connection circuit 106-A and a bus 108-A, while computer 120-B includes a CPU 102-B. input/output devices 104-B, a network connection circuit 106-B and a bus 108-B. For the purpose of simplicity, individual components, e.g., 102-A and 102-B, are collectively referenced only by their number, e.g., 102.

The input/output devices 104 may include standard components, such as a keyboard, mouse, display, printer, and the like. The network connection circuit 106 provides connectivity to communication channel 130.

In the client computer 120-A, also connected to the bus 108-A is a memory 140. The memory 140 stores executable instructions to implement operations of the invention. In an embodiment, the memory 140 stores one or more of the following modules: a template creation module 142, a template consumption module 144, a Graphical User Interface (GUI) module 146, and an optional BI module 148.

The template creation module 142 includes executable instructions to aid a user in creating a new custom template. The executable instructions include instructions to navigate the user through a custom template creation guide, accept default or user indicated template specifications and compile a custom template object in accordance with the template specifications. The template creation module 142 also includes executable instructions for publishing the custom template to a repository.

The template consumption module 144 includes executable instructions to aid a user in consuming or implementing an existing custom template. The executable instructions include instructions to accept a default or user selected custom template, run a custom template consumption guide, accept default or user specified parameters and render an instance of the associated visualization.

The GUI module 146 may rely upon standard techniques to produce graphical components of a user interface, e.g., windows, icons, buttons, menus and the like. The user interface may include instructions to receive input from a pointer device and display a cursor on an output device.

The BI module 148 includes executable instructions to perform BI related functions on computers 120-A or 120-B, across network 130 or a wider network. BI related functions include: generating reports (locally or on a server), viewing a report, performing query and analysis, and the like. In an embodiment, the BI module 148 can include sub-modules, such as a report module, a server communications module and the like.

In the server computer 120-B, connected to the bus 108-B is a memory 160. The memory 160 stores executable instructions to implement operations of the invention. In an embodiment, the memory 160 stores one or more of the following modules: a template repository module 162 and a template repository 164.

The template repository module 162 includes executable instructions to interact with the template repository 164, adding, editing and retrieving templates from the template repository 164. The template repository module 162 receives and responds to requests from the client computer 120-A.

The modules stored in memory 140 and 160 are exemplary. Additional modules, such as an operating system can be included. It should be appreciated that the functions of the presented modules may be combined. In addition, a function of a module need not be performed on a single machine, e.g., the first computer or the second computer. Instead, the function may be distributed across system 100 or a wider network, if desired. In an embodiment, the template creation module 142 and the template consumption module 144 reside on separate machines. Indeed, it is possible that a first client machine may only create custom templates and second client machine may only consume custom templates, while a third client machine may perform both actions. In an embodiment of the present invention, the system 100 may operate in a non-client-server architecture. Indeed, the template repository 164 may exist on the client machine 120-A, eliminating the need for a server machine 120-B. In an embodiment, the system 100 may operate in a peer-to-peer architecture.

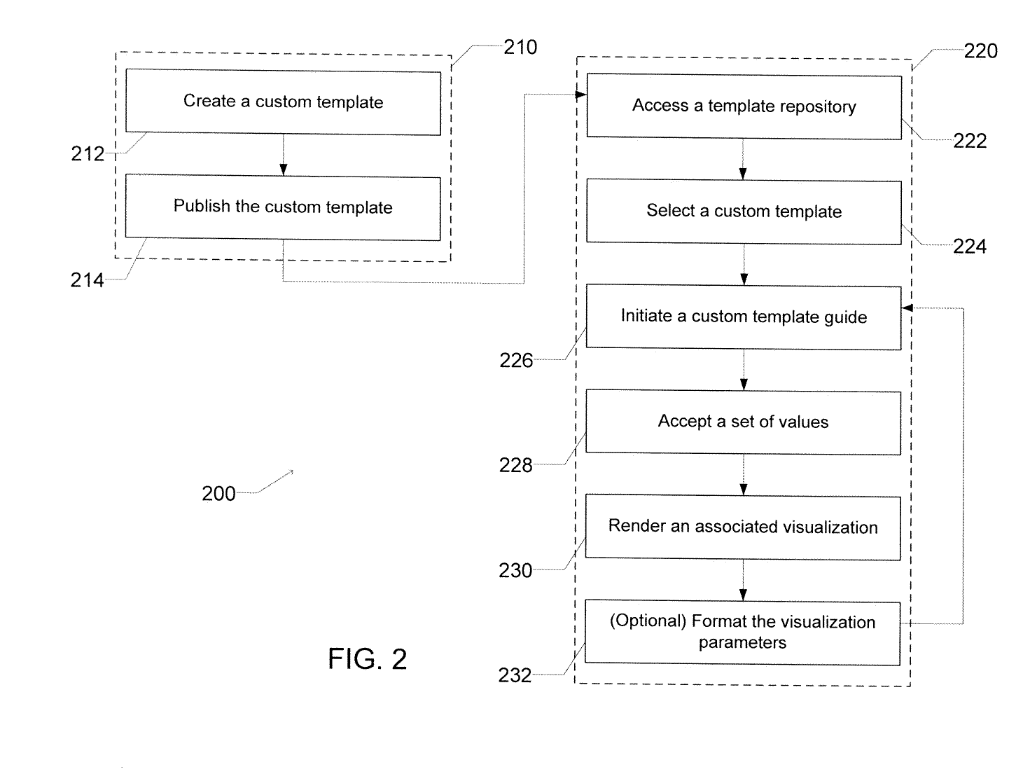

FIG. 2 illustrates a workflow 200 associated with an embodiment of the invention. The set of operations 210 relate the process of creating a custom template and the set of operations 220 relate the process of consuming a custom template. Provided there are custom templates available, the processing operations 210 are not required.

The first operation 212 of the operations 210 is to create a custom template for a visualization. In an embodiment, this is done via a template creation guide. The template creation module 142 initiates a template creation guide. The guide prompts a user to indicate the specifications of the custom template, including the image used for the visualization and any data mappings. In an embodiment, the image is selected from a vendor repository or user repository, or created by the user. In an embodiment, the user selects multiple data sources for the visualization and provides a data mapping to associate the data sources. In an embodiment, one or more of the specifications are completed by default values. The second operation 214 is to publish the custom template to a repository. In an embodiment, the repository is stored locally. In another embodiment, the repository is located on a server computer linked by a network.

The first operation 222 of the operations 220 is to access a visualization template repository. In an embodiment, the visualization template repository contains both custom templates and vendor provided templates. In an embodiment, the template repository is automatically updated to reflect its current contents without requiring the user to refresh. In the second operation 224, the user selects a custom template and the template consumption module 144 initiates a custom template consumption guide 226. The template consumption guide accepts a set of values 228 that specify the parameters to implement a visualization associated with the template. In an embodiment, a parameter may be specified using a formula. The custom template consumption module 144 renders an instance of the visualization 230 in accordance with the specified parameters, which is displayed by the GUI module 146. The user may opt to format the visualization parameters 232, which reinitiates the custom template guide 226. The user may format the visualization multiple times. In an embodiment, the user may save a version of the visualization before reformatting.

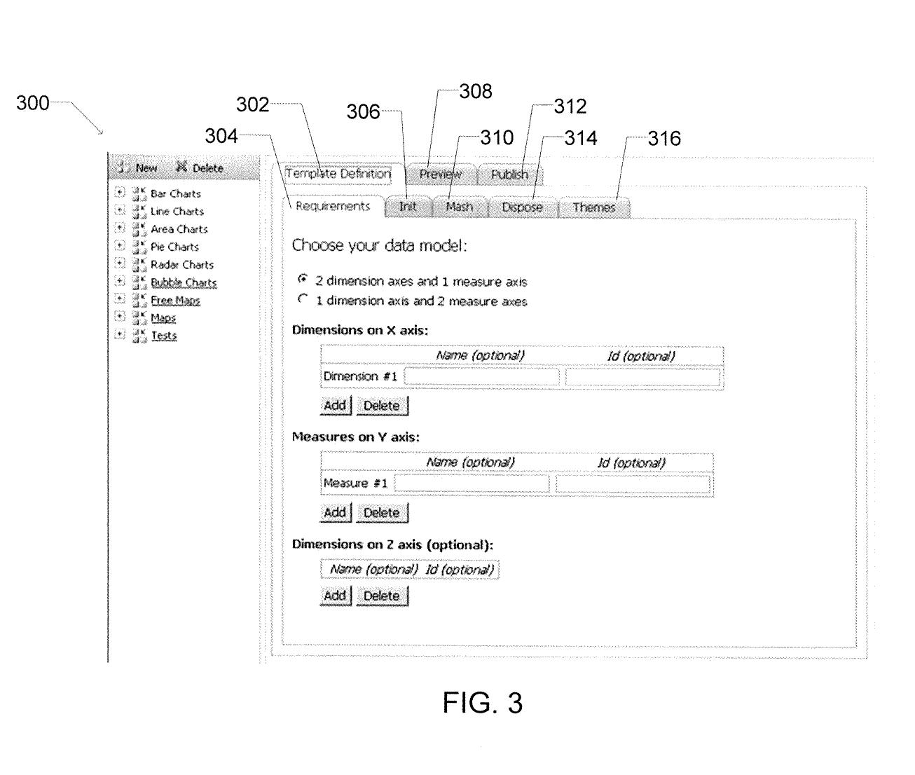

FIG. 3 illustrates a custom template creation guide 300 configured in accordance with an embodiment of the invention. The tabs 302-316 provide logical groupings of related specifications to be indicated by the user. In an embodiment, the guide 300 directs the user through completing the specifications by presenting a single tab or a section of a tab at a time. In an embodiment, a Template Definition tab 302 contains sub-tabs for indicating the specifications for the custom template (e.g., the Requirements tab 304, the Init (or Initialization) tab 306, the Mash tab 310 and the Dispose tab 314).

The Requirements tab 304 allows the user to indicate the axes of a chart visualization. In an embodiment, the user may use the custom template creation guide 300 to create a mashup template. The tabs Init 306, Mash 310 and Dispose 314 specify code to run when the mashup is first instantiated, code to run when the mashup parameters are specified and the mashup is rendered, and code to run upon deleting the mashup. In an embodiment, the Themes tab 316 allows the user to indicate parameter options for the template consumption user to select from when using the template and specify a default setting.

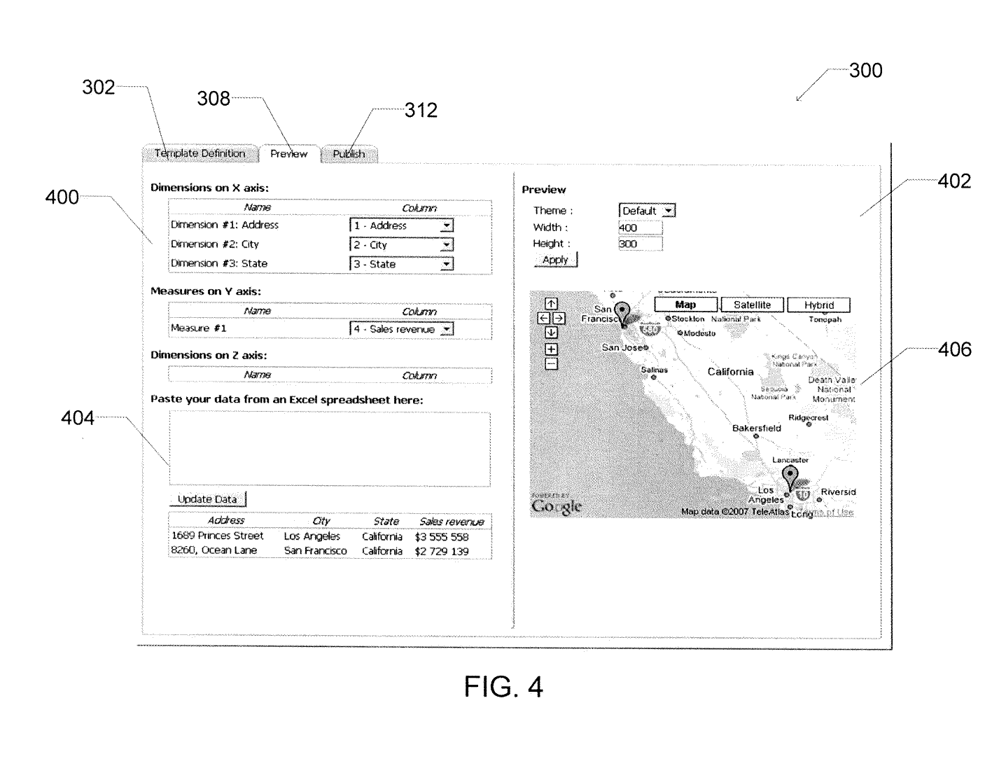

FIG. 4 illustrates the Preview tab 308 of the custom template creation guide 300. In an embodiment, after indicating the specifications of the custom template via the Template Definition tab 302, the user can preview the result. In an embodiment, the Preview tab 308 is divided into two sections: the specifications panel 400 and the display panel 402. The specifications panel 400 shows the specifications of the template and allows the user to supply data via a text box 404 to test the template. The display panel 402 displays the resulting visualization instance 406. The Publish tab 312 assists the user in publishing the custom template to a repository. In an embodiment, the user may opt to associate data with the published template.

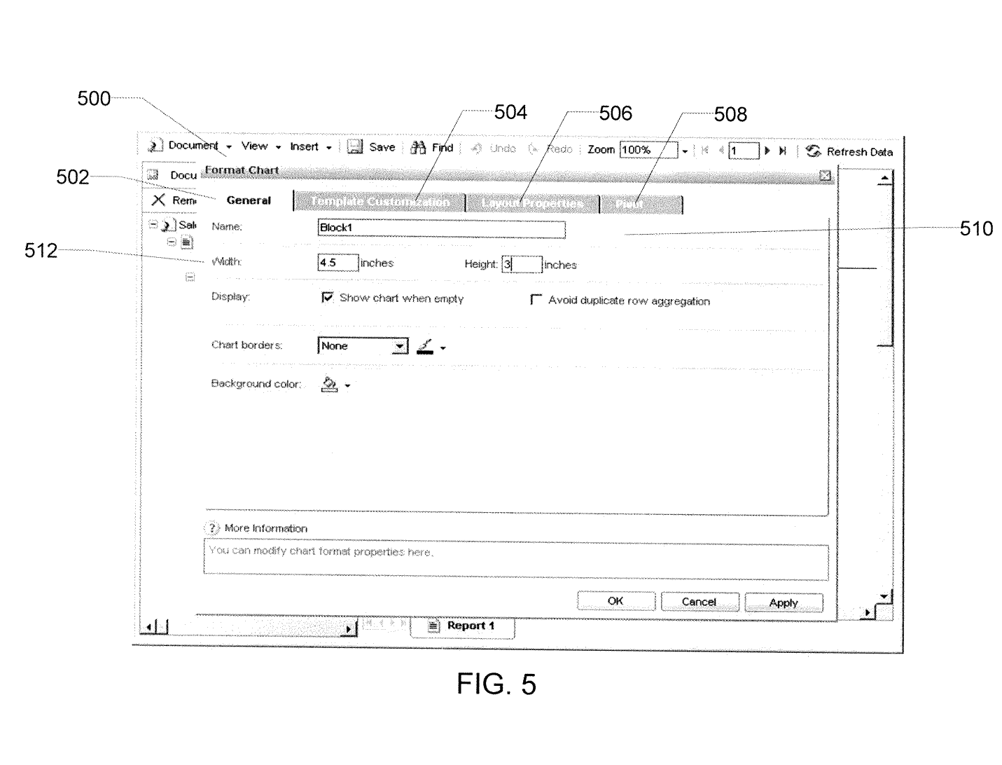

FIG. 5 illustrates a template consumption guide 500 configured in accordance with an embodiment of the invention. The tabs 502-508 provide logical groupings of related parameters to be specified by the user. In an embodiment, some of the template specifications provide a set of possible parameters, which were indicated during the custom template creation process. In an embodiment, the template consumption guide 500 provides default parameters for some or all of the template specifications. In an embodiment, the guide 500 directs the user through completing the parameters by presenting a single tab or a section of a tab at a time. In an embodiment, a General tab 502 allows the user to specify basic parameters for the visualization such as name 510 and size 512.

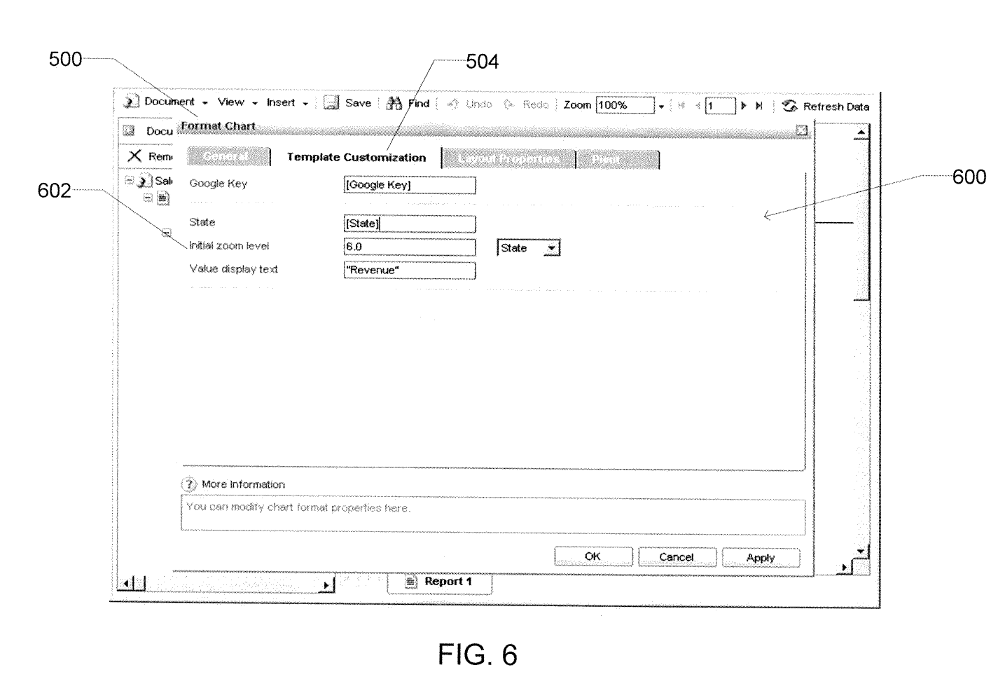

FIG. 6 illustrates a Template Customization tab 504 of the template consumption guide 500 configured in accordance with an embodiment of the invention. In an embodiment, the Template Customization tab 504 is specific to each custom template consumption guide 500. It allows the user to specify parameters for specifications 600 that are specific to the custom template such as initial zoom level 602 in the case of a map visualization.

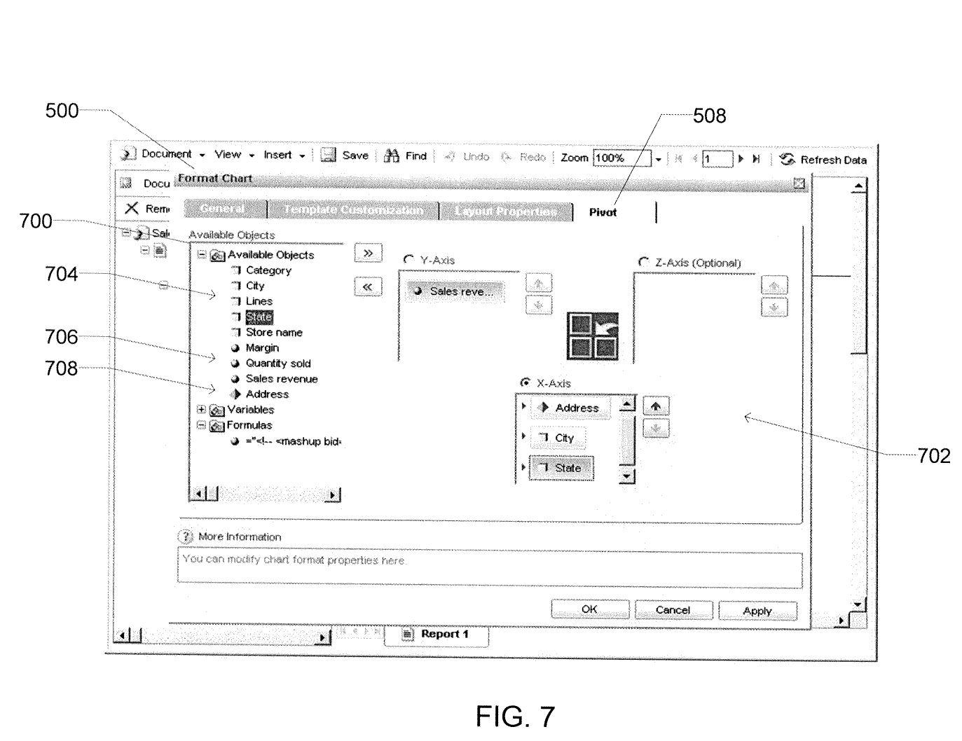

FIG. 7 illustrates a Pivot tab 508 of the template consumption guide 500 configured in accordance with an embodiment of the invention. In an embodiment, the Pivot tab 508 allows the user to specify which of an available set of data attributes 700 should appear on each of the available axes 702. In an embodiment, the data attributes are selected from one or more of attributes defined by the data source 704, measures defined by the data source or the template creator 706, and custom attributes defined by the template creator 708.

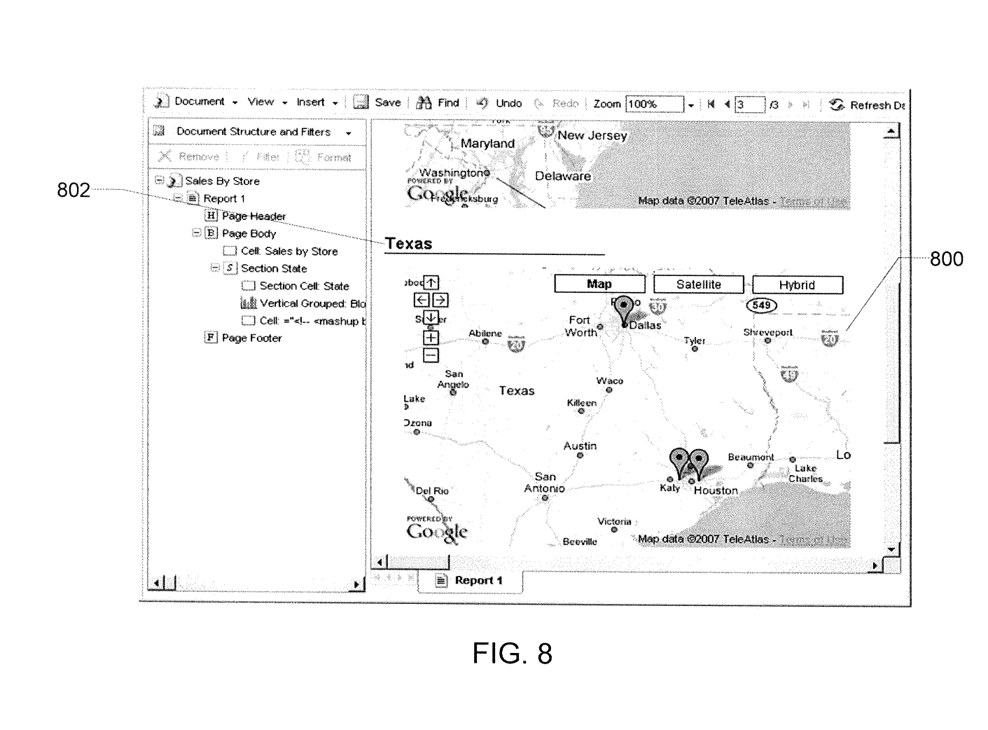

FIG. 8 illustrates the result of inserting a visualization 800 created using the custom template consumption guide into a report. In an embodiment, when the visualization 800 is inserted into a context specific section of a report 802, the visualization 800 reflects context specific data. In an embodiment, the user may opt to allow the visualization to reflect context specific data or to have the visualization reflect the entire dataset.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
access multiple custom templates;
designate a selected custom template for implementation, wherein the selected custom template has a set of associated parameters; and
initiate a custom template guide corresponding to the selected custom template.

2. The computer readable storage medium of claim 1 further comprising executable instructions to accept, via the custom template guide, a set of values which correspond to the set of associated parameters.

3. The computer readable storage medium of claim 2 further comprising executable instructions to render an instance of a visualization in accordance with the set of values.

4. The computer readable storage medium of claim 2 wherein the template guide provides a set of default values.

5. The computer readable storage medium of claim 3 further comprising executable instructions to:
accept a request to format the instance of the visualization; and
reinitiate the custom template guide.

6. The computer readable storage medium of claim 1 further comprising executable instructions to:
accept a set of specifications to create a custom template for a visualization, wherein the custom template has a set of associated parameters; and
publish the custom template to a repository.

7. The computer readable storage medium of claim 6, wherein the custom template is selected from the repository.

8. The computer readable storage medium of claim 2, wherein a value in the set of values is specified using a formula.

9. The computer readable storage medium of claim of 3 further comprising executable instructions to insert the instance of the visualization into a report.

10. The computer readable storage medium of claim 9, wherein the set of values used to render the instance of the visualization is data context specific to a section of the report.

11. The computer readable storage medium of claim 6 further comprising executable instructions to request the set of specifications via a custom template creation guide.

12. The computer readable storage medium of claim 6 further comprising executable instructions to:
select an existing custom template;
modify a set of associated specifications; and
publish the existing custom template to the repository.

13. A computer readable storage medium, comprising executable instructions to:
access multiple custom templates;
designate a selected custom template for implementation, wherein the selected custom template has a set of associated parameters;
initiate a custom template guide corresponding to the selected custom template;
accept, via the custom template guide, a set of values which correspond to the set of associated parameters; and
render an instance of a visualization in accordance with the set of values.

14. The computer readable storage medium of claim 13 wherein the template guide provides a set of default values.

15. The computer readable storage medium of claim 13 further comprising executable instructions to:
accept a request to format the instance of the visualization; and
reinitiate the custom template guide.

16. The computer readable storage medium of claim 13 further comprising executable instructions to:
accept a set of specifications to create a custom template for a visualization, wherein the custom template has a set of associated parameters; and
publish the custom template to a repository.

17. The computer readable storage medium of claim 16, wherein the custom template is selected from the repository.

18. The computer readable storage medium of claim 13, wherein a value in the set of values is specified using a formula.

19. The computer readable storage medium of claim of 13 further comprising executable instructions to insert the instance of the visualization into a report.

20. The computer readable storage medium of claim 19, wherein the set of values used to render the instance of the visualization is data context specific to a section of the report.

21. The computer readable storage medium of claim 16 further comprising executable instructions to:
select an existing custom template;
modify a set of associated specifications; and
publish the existing custom template to the repository.

22. A computer readable storage medium, comprising executable instructions to:
access multiple custom templates;
designate a selected custom template for implementation in a report, wherein the selected custom template has a set of associated parameters;
initiate a custom template guide corresponding to the selected custom template;
request, via the custom template guide, a set of values which correspond to the set of associated parameters;
render an instance of a visualization in accordance with the set of values; and
insert the instance of the visualization into the report.

23. The computer readable storage medium of claim 22, wherein the set of values used to render the instance of the visualization is data context specific to a section of the report.
